(19) United States
(12) Patent Application Publication
(10) Pub. No.: US 2017/0136671 A1
(43) Pub. Date: May 18, 2017

(54) MANAGEMENT SYSTEM OF INJECTION MOLDING MACHINES

(71) Applicant: FANUC Corporation, Yamanashi (JP)

(72) Inventor: Tatsuhiro UCHIYAMA, Yamanashi (JP)

(21) Appl. No.: 15/352,719

(22) Filed: Nov. 16, 2016

(30) Foreign Application Priority Data
Nov. 17, 2015 (JP) 2015-224656

(51) Int. Cl. B29C 45/76; G05B 19/18; G05B 19/408

(52) U.S. Cl. CPC B29C 45/768; G05B 19/408; G05B 19/182; B29C 2945/76163; G05B 2219/2624

(57) ABSTRACT

A management system of injection molding machines includes molding cells, each of which including at least an injection molding machine and a temporary storage device configured to store data from devices in each molding cell at prescribed intervals, and a management device that is connected with the molding cells through communications lines and stores the data stored in the temporary storage device. The temporary storage device overwrites the data sequentially from the oldest data to the newest data in cycles, and stores the data for a prescribed number of cycles. A signal that is selected in advance from signals generated by the devices in each molding cell or by the management device is input to the temporary storage device as a trigger signal, and when the temporary storage device receives the trigger signal, the temporary storage device outputs the stored data to the management device.

### BACKGROUND OF THE INVENTION

1. Field of the Invention

The present invention relates to a management system that collects data, such as data on the operation status of each apparatus, especially an injection molding machine in molding cells for producing molded articles and molding data.

2. Description of the Related Art

A management systems for injection molding machines that detects and stores the operation status of the injection molding machines and various kinds of molding data, and tabulates and analyzes the stored data to be utilized for production control, such as inspection timing of the injection molding machines and production control planning, has been known. In addition, a central management system for a factory equipped with a plurality of injection molding machines has been developed, in which the injection molding machines are connected with a central management device such as a personal computer through a network and the data on the operation condition and the molding data of the injection molding machines are automatically collected. For example, JP 10-58509 A discloses a management system that collects data such as power-on time of injection molding machines, heater warming time, alarm generation time, suspension time after production completion, manual operation time, semi-automatic operation time, automatic operation time, and tabulates and stores these data on a daily basis for a month ora monthly basis for a year, and enables displaying these data. JP 10-58509 A also discloses a central management system in which a plurality of injection molding machines are connected to a central management device through communications lines, and the central management device centrally collects and analyzes the above various kinds of data of each of the injection molding machines and enables displaying these data.

A molding factory including a plurality of molding cells, each of which includes injection molding machines and peripheral apparatuses, such as a molded article unloading apparatus, a robot, a molded article imaging apparatus, and a molded article measurement apparatus, has been known. Also, a technique to centrally collect molding data indicating the operation status and the molding movement conditions of various devices in the molding cells has been known. For example, JP 2006-175619 A discloses an invention directed to a molding machine monitoring device that includes a plurality of molding cells each of which includes an injection molding machine provided with a molded article imaging apparatus and a molded article unloading apparatus, and also includes individual databases each of which stores various kinds of measurement values of various kinds of measurement data and the like indicating operation conditions of the molding machines, (e.g. mold temperatures, resin temperatures, pressures, time of measurement step, filling step, dwelling step, and the like, and molding cycle time, etc.) and also stores images of molded articles and the like acquired by the imaging device. Each of the molding cells is connected to a monitoring terminal having a collective database through an internal network, and the data stored in the individual database of each of the molding cells is transmitted to the collective database and stored therein at prescribed intervals.

When a plurality of injection molding machines and molding cells are connected to one central management device through a network of communications lines to collect the operation conditions and various kinds of molding data of machines such as the injection molding machines, the amount of the data collectable by the central management device depends on the communication speed and communication capacity of the network. While developments in machines enabling high-speed communication and developments in network infrastructure have increased communicable amount of data, molding factories have grown very large in scale, and thus the numbers of injection molding machines and molding cells which should be centrally managed are also on the increase. Accordingly, depending on the specification of the network, it is becoming more difficult to centrally manage all of the injection molding machines and the molding cells in a molding factory with one central management device.

### SUMMARY OF THE INVENTION

An object of the present invention is to provide a central management system of injection molding machines capable of reducing communication traffic on communications lines and also capable of acquiring data necessary for controlling molding cells including injection molding machines and the like, even when the communication traffic is reduced.

According to an aspect of the invention, a management system of injection molding machines includes a plurality of molding cells each of which is provided for an injection molding machine, each of the molding cells including at least the injection molding machine and a temporary storage device configured to store data at prescribed intervals, the data being detected by and output from devices included in each of the molding cells, and a management device that is connected with the molding cells through communications lines and acquires and stores the data stored in the temporary storage device. The temporary storage device overwrites the data stored at the prescribed intervals sequentially from the oldest data to the newest data in cycles, and stores the data for a prescribed number of cycles. A signal that is selected in advance from signals generated by the devices included in each of the molding cells or by the management device is input to the temporary storage device as a trigger signal, and when the temporary storage device receives the trigger signal, the temporary storage device outputs the stored data to the management device. This enables reducing communication traffic on the communications line and also acquiring necessary and sufficient data.

In the management system of injection molding machines, the prescribed intervals may be either of prescribed time intervals or intervals of a prescribed number of molding cycles, and each of the molding cells may include at least one of peripheral machines other than the injection molding machines, the peripheral machines including a molded article unloading apparatus or a robot, a molded article imaging apparatus, and a molded article measurement apparatus.

In the management system of injection molding machines, a control device of the injection molding machine may also serve as the temporary storage device, and a storage unit in the control device of the injection molding machine may store the data detected by and output from the devices included in each of the molding cells. In the management system of injection molding machines, any one of a signal detecting a defective molded article manufactured in the molding cells, a signal detecting an anomaly of the devices included in each of the molding cells, or a signal of an instruction by an operator to transmit the data stored in the temporary storage device through the devices included in each of the molding cells or the management device to the management device may be used as the trigger signal.

According to the aspect of the present invention, data is transmitted to the management device only when data regarding the molding cells is required. Accordingly, communication traffic on the communications lines of a network can be reduced, and in addition, the management device stores only useful information for a manager who manages a molding factory, such as data at the time of occurrence of a molding failure or an anomaly. This reduces the storage capacity of the management device and facilitates retrieving necessary and sufficient data.

### BRIEF DESCRIPTION OF THE DRAWINGS

The foregoing and other objects and features of the invention will be apparent from the following description of the embodiments taken in conjunction with the accompanying drawings, in which:

FIG. 1 is a schematic view of one embodiment of the present invention; and

FIG. 2 is a flowchart illustrating an algorithm of processes which a control device of a temporary storage device according to the embodiment performs at prescribed intervals.

### DETAILED DESCRIPTION OF THE PREFERRED EMBODIMENTS

Embodiments of the present invention are described below with reference to the drawings.

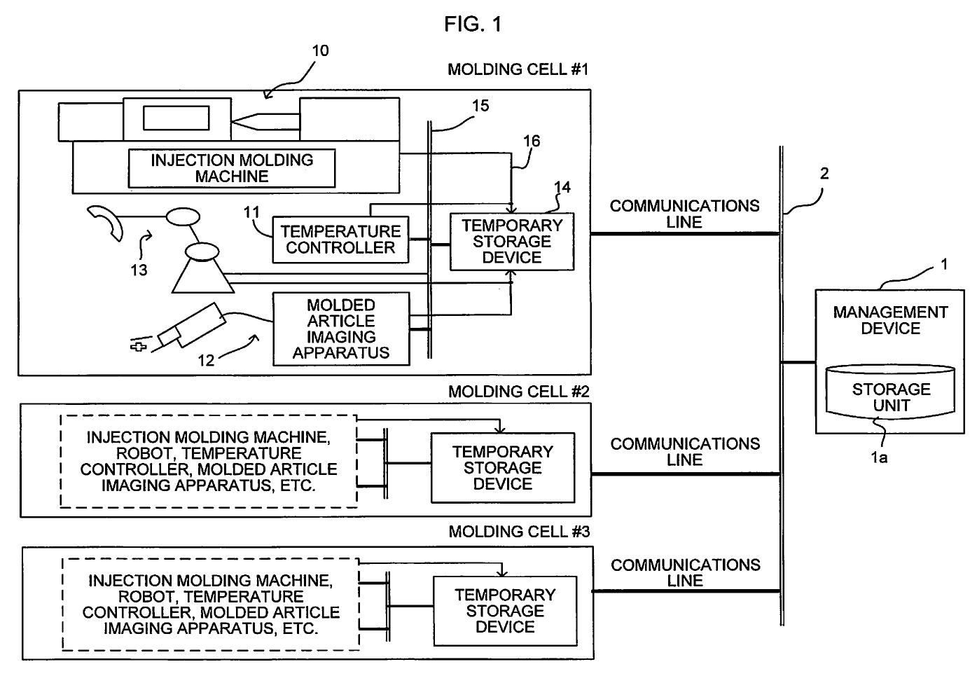

FIG. 1 is a schematic view of one embodiment of the present invention. A plurality of molding cells are connected to a management device 1 through a network of communications lines 2. In an example shown in FIG. 1, a molding cell #1, a molding cell #2, and a molding cell #3 are connected to the management device 1.

Each of the molding cells includes an injection molding machine 10, a temporary storage device 14 configured to temporarily store various kinds of data, peripheral apparatuses that operate in accordance with a molding operation of the injection molding machine. At least the injection molding machine 10 and the temporary storage device 14 configured to temporarily store various kinds of data are essential components of each of the molding cells. FIG. 1 illustrates an example of an inner structure of the molding cell #1 that includes the injection molding machine 10, the temporary storage device 14 configured to temporarily store various kinds of data of the devices in the molding cell, and peripheral apparatuses of a temperature controller 11 configured to control a mold temperature, a molded article imaging apparatus 12 configured to image molded articles, and a robot 13 configured to unload the molded articles or perform other operations accompanied by the molding operation. The devices in each of the molding cells are connected with each other through communications lines 15 in the molding cells. The temporary storage device 14 is capable of receiving a trigger signal 16 (described below) from the injection molding apparatus 10 and from a control device (not shown) of the peripheral apparatuses, i.e., the temperature controller 11, the molded article imaging apparatus 12, and the robot 13.

The molding cells other than the molding cell #1 have similar structures. Some molding cells include a molded article unloading apparatus instead of the robot 13, or include a molded article measurement apparatus, and some does not include a molded article imaging apparatus 12. Every molding cell includes at least the injection molding apparatus 10 and the temporary storage device 14.

The temporary storage devices of the molding cells #1 to #3 are connected to the management device 1 by the communications lines 2 of the network. The management device 1 includes a storage unit la configured to store data, and centrally manages the various kinds of data generated by the plurality of molding cells.

The temporary storage device 14 collects the data of the devices in the molding cell (injection molding machine 10 and its peripheral apparatuses including temperature controller 11, molded article imaging apparatus 12, robot 13, and the like) at prescribed intervals (every prescribed period or every prescribed number of molding cycles) through the internal communications lines 15. When receiving the trigger signal, the temporary storage device 14 transmits the temporarily stored data to the management device 1 that is configured to centrally manage the data.

Note that the prescribed intervals for collecting the data may be either of every prescribed period or every prescribed number of molding cycles. In the case where the data is collected every prescribed number of molding cycles, the control device of the injection molding machine counts the number of the molding cycles and is configured to output a trigger signal when the number of the molding cycles reaches a prescribed number. Alternatively, the data maybe collected in such a manner that the temporary storage device receives signals each indicating an end of a molding cycle from the injection molding machine, counts the number of the signals, and generates a trigger signal when the number of the signals reaches a prescribed number.

The data generated by the devices in each molding cell are as follows:

1) Data on an injection molding machine
operation status: under automatic operation, under manual operation, under suspension, and the like
molding data per molding cycle: injection time, peak value of injection pressure, temperatures of nozzles and cylinders, and the like
waveform data: molding data, data of physical quantities recorded with elapse of time, such as a pressure of a resin or a screw position
operation record: operation contents of a screen and a button
alarm generation record: date and details

2) Data on a unloading device or a robot
operation status: under automatic operation, under manual operation, under suspension, and the like
waveform data: load data of a shaft drive motor
operation record: operation contents of a screen and a button
alarm generation record: date and details

3) Data on a molded article imaging apparatus
image data of molded articles
quality determination results of molded articles according to the images

4) Data on a molded article measurement apparatus (quantity measurement apparatus, size measurement apparatus)
measurement results of quantities or sizes of molded articles
quality determination results of molded articles according to the quantity or the size

5) Data on a temperature controller and a dryer
operation status: under operation, under suspension
temperature data

A signal generated when an operator operates the management device 1 is input to the temporary storage device as a trigger signal and the management device is allowed to acquire the data stored in the temporary storage device in the case where the injection molding machine 10 detects a molding failure or an anomaly of the molding data, the molded article imaging apparatus 12 detects a molding failure, the injection molding machine 10 or its peripheral apparatus (temperature controller 11, molded article imaging apparatus 12, robot 13, or the like) generates an alarm, an operator presses an emergency stop button on the injection molding machine, an operation of a sampling inspection of molded articles is performed, or a manager of the factory needs to acquire the data in the molding cells to grasp the operation status of the molding cells, for example. In other words, a signal to be utilized as a trigger signal is selected in advance from the signals generated by the devices in the molding cells, or the management device. Note that when the trigger signal is output from the management device 1, an operator inputs a data transmission instruction to the management device 1 together with a code specifying the molding cell from which the data is to be acquired, and inputs a trigger instruction to the temporary storage device of the specified molding cell through the communications lines 2, and then the data stored in the temporary storage device is transmitted to the management device 1. Alternatively, the data may be transmitted in such a manner that a signal line for a trigger signal is connected from the management device to the temporary storage device of each of the molding cells, and a trigger instruction is output through the signal line.

Although this embodiment exemplifies a case where a trigger signal line is provided in each of the molding cells, a trigger signal (or a trigger instruction) may be transmitted from the injection molding machine 10 or its peripheral apparatus (temperature controller 11, molded article imaging apparatus 12, or robot 13) to the temporary storage device 14 through the communications line 15 without providing a trigger signal line.

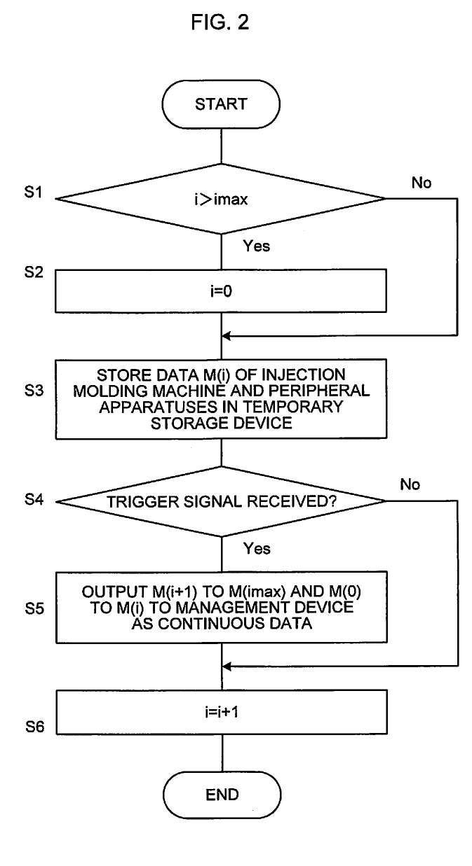

FIG. 2 is a flowchart illustrating an algorithm of processes performed by a control device of the temporary storage device 14 of each of the molding cells at prescribed intervals. Note that the temporary storage device 14 is configured to repeat a process to overwrite the oldest data and store the newest data when the storage capacity thereof is fully occupied, and is managed by using an index i.

The control device of the temporary storage device 14 determines whether the index i exceeds a value imax indicating the maximum value of the storage capacity (step S1), and resets the index i to 0 when the index i exceeds the value imax (step S2). Note that the index i is initially set at 0 at the time of continuous manufacturing of molded articles. The temporary storage device 14 then stores the above described various kinds of data M(i) of the injection molding machine 10 and the peripheral apparatuses (step S3). Then, the control device determines whether or not the trigger signal is input (step S4). When the control device determines that the trigger signal is not input, the process proceeds to step S6 to add 1 to the index i, and a cycle of the processes is finished. Subsequently, the processes of step S1 to step S4 and step S6 are performed in each cycle, and various kinds of data generated by the devices in each of the molding cells is collected and stored in the temporary storage device 14.

When the index i exceeds the maximum value imax, the process proceeds from step S1 to step S2, and the index i is reset to 0. Accordingly, the newest data is stored by overwriting the oldest data stored in the temporary storage device 14 in step S3.

While the various kinds of data generated in the devices in the molding cell are collected and stored in the temporary storage device 14, when a trigger signal 16 is received from the injection molding machine 10, its peripheral apparatus (temperature controller 11, molded article imaging apparatus 12, robot 13, or the like), or the management device 1, the process proceeds from step S4 to step S5, and data M(i+1) to M(imax), and M(0) to M(i), which are indicated by the index i, are input to the management device 1 as continuous data. Specifically, data M(i) indicated by the index i is the newest data, and data M(i+1) is the oldest data in the stored data and is to be overwritten in the next cycle. Accordingly, the data are output with the oldest first in the order of M(i+1), M(i+2), M(imax), and M(0), M(1), . . . M(i).

On the other hand, when receiving the data from each of the molding cells, the management device 1 stores the received data in the storage unit la together with a code identifying the molding cell. The stored data is displayed or printed to be utilized for managing the molding cells.

As described above, the temporary storage device 14 in each of the molding cells stores the data of a limited number of cycles (imax+1), such as the detected data of the devices in each of the molding cells sampled at prescribed intervals, and thus the storage capacity is needed only for a prescribed number of cycles (number of cycles corresponding to imax+1). In addition, the temporary storage device 14 stores the past data of a prescribed number of cycles (number of cycles corresponding to imax+1) prior to the cycle in which a trigger signal is generated due to an occurrence of a molding failure or an anomaly, and the stored data is transmitted to the management device 1. As a result, the management device 1 stores only useful information for a manager of a molding factory, such as the data at the time of a molding failure, the data at the time of an anomaly, and the data on a sampled molded article. This makes it possible to acquire sufficient data for operation analysis of the molding cells, and facilitates retrieving necessary data. In other words, the number of cycles (imax+1) for storing data in the temporary storage device may be a number in a range that is useful for analyzing the data related to a past molding operation at the time of occurrence of a molding failure or an anomaly, and thus the capacity of the temporary storage device need not be large. In addition, the data transmission to the management device through the network of the communications lines 2 is not performed at prescribed intervals, but is limited to a time only when an anomaly occurs or when a manager considers the data transmission necessary, or the like. Accordingly, communication traffic on the network can be reduced, and the storage capacity of the storage unit 1a of the management device 1 can be reduced.

Note that the temporary storage device 14 provided in each of the molding cells may be an independent temporary storage device, or a personal computer. In addition, the control device of the injection molding machine may also serve as the temporary storage device. Specifically, a processor of the control device of the injection molding machine may perform processes illustrated in FIG. 2 at prescribed intervals, and the storage unit in the control device may be configured to store the data detected in the injection molding machine and the data of the peripheral apparatuses (temperature controller 11, molded article imaging apparatus 12, robot 13, and the like).

Although an embodiment of the present invention is described above, the present invention is not limited to the examples of the above described embodiment, and can be achieved in other aspects of the invention by applying appropriate modifications.

1. A management system of injection molding machines comprising:
a plurality of molding cells each of which is provided for an injection molding machine, each of the molding cells including at least the injection molding machine and a temporary storage device configured to store data at prescribed intervals, the data being detected by and output from devices included in each of the molding cells; and
a management device that is connected with the molding cells through communications lines and acquires and stores the data stored in the temporary storage device, wherein
the temporary storage device overwrites the data stored at the prescribed intervals sequentially from the oldest data to the newest data in cycles, and stores the data for a prescribed number of cycles,
a signal that is selected in advance from signals generated by the devices included in each of the molding cells or by the management device is input to the temporary storage device as a trigger signal, and
when the temporary storage device receives the trigger signal, the temporary storage device outputs the stored data to the management device.

2. The management system of injection molding machines according to claim 1, wherein
the prescribed intervals are either of prescribed time intervals or intervals of a prescribed number of molding cycles.

3. The management system of injection molding machines according to claim 1, wherein
each of the molding cells includes at least one of peripheral apparatuses, the peripheral apparatuses including a molded article unloading apparatus or a robot, a molded article imaging apparatus, and a molded article measurement apparatus, and
each of the molding cells also includes the data of the at least one of the peripheral apparatuses.

4. The management system of injection molding machines according to claim 1, wherein
a control device of the injection molding apparatus also serves as the temporary storage device, and a storage unit in the control device of the injection molding machine stores the data detected by and output from the devices included in each of the molding cells.

5. The management system of injection molding machines according to claim 1, wherein
the trigger signal is any one of a signal detecting a defective molded article manufactured in the molding cells, a signal detecting an anomaly of the devices included in each of the molding cells, or a signal of an instruction by an operator to transmit the data stored in the temporary storage device through the devices included in each of the molding cells or the management device to the management device.
